(19) United States
(12) Patent Application Publication
(10) Pub. No.: US 2025/0048067 A1
(43) Pub. Date: Feb. 6, 2025

(54) IN-VEHICLE COMMUNICATION APPARATUS AND OPERATION METHOD THEREOF

(71) Applicant: LG ENERGY SOLUTION, LTD., Seoul (KR)

(72) Inventor: Jeong Jae JO, Daejeon (KR)

(73) Assignee: LG ENERGY SOLUTION, LTD., Seoul (KR)

(21) Appl. No.: 18/716,439

(22) PCT Filed: Nov. 21, 2022
(86) PCT No.: PCT/KR2022/018431

§ 371 Date: Jun. 4, 2024

(30) Foreign Application Priority Data
Jan. 4, 2022 (KR) 10-2022-0001206

(51) Int. Cl. H04W 4/48; B60R 16/023; H04L 67/12

(52) U.S. Cl. CPC H04W 4/48; B60R 16/023; H04L 67/12

(57) ABSTRACT

An in-vehicle communication apparatus according to an example embodiment, which is proposed to improve data transmission rate without data drop by supporting conversion between different communication interfaces, includes a communication unit configured to perform first communication with a first module configured to manage state data of a vehicle and second communication with a second module configured to communicate with the outside and a controller configured to acquire the state data of the vehicle from the first module and transmit the state data of the vehicle to the second module.

### TECHNICAL FIELD

### Cross-Reference to Related Application

This application claims priority to Korean Patent Application No. 10-2022-0001206, filed Jan. 4, 2022, the entire contents of which is incorporated herein for all purposes by this reference.

### Technical Field

Example embodiments disclosed in this document relate to an in-vehicle communication apparatus and an operation method thereof.

### BACKGROUND ART

On-Board Diagnostics (OBD), as a diagnostic standard for checking and controlling the electrical/electronic operation of a vehicle, was initially used to improve maintenance efficiency of electronic parts such as engines but has recently served as a trip computer with an interface to show drivers various vehicle information.

In general, an OBD system is provided with a microcontroller unit (MCU) that acquires and manages vehicle state data and a communication module (e.g., an LTE module such as EC25-E) that receives data from the MCU and exchanges data with external servers, terminals, etc. through a wireless communication network. Particularly in the case of a conventional LTE module, data exchange with MCU is performed through a Universal Asynchronous Receiver/Transmitter (UART) interface, which has a maximum transmission rate slower than that of a Serial Peripheral Interconnect (SPI) and causes additional delay due to being pushed back by high-priority functions (CAN communication, data storage function, etc.). As a result, real-time LTE communication increases the load on the vehicle MCU.

### DISCLOSURE

### Technical Objective

An object of the example embodiments disclosed in this document is to provide an in-vehicle communication apparatus and an operation method thereof for supporting conversion between different communication interfaces and relaying data transmission and reception through an appropriate time delay.

The technical objects of the example embodiments disclosed in this document are not limited to the aforesaid, and other objects not described herein with be clearly understood by those skilled in the art from the descriptions below.

### Technical Solution

An in-vehicle communication apparatus according to an example embodiment includes a communication unit configured to perform first communication with a first module managing state data of a vehicle and second communication with a second module communicating with the outside and a controller configured to acquire the state data of the vehicle from the first module and transmit the state data of the vehicle to the second module.

In the in-vehicle communication apparatus according to an example embodiment, the controller may acquire data in units of a set size from the first module and transmit the data in units of a set size to the second module.

In the in-vehicle communication apparatus according to an example embodiment, the controller may acquire the following data after a set time delay upon acquiring the data in units of the set size from the first module.

In the in-vehicle communication apparatus according to an example embodiment, the time delay may be set in consideration of the time required for the controller to acquire the data of the set size unit from the first module and the time required for transmitting the data of the set size unit to the second module.

In the in-vehicle communication apparatus according to an example embodiment, a size of a transmission buffer of the vehicle communication apparatus may be set in consideration of the set time delay and an additional time delay caused by a size of a transmission buffer of the first module.

In the in-vehicle communication apparatus according to an example embodiment, the first communication may be faster in data transmission rate per second than the second communication.

In the in-vehicle communication apparatus according to an example embodiment, an interface of the first communication may be a Serial Peripheral Interconnect (SPI), and an interface of the second communication interface may be a Universal Asynchronous Receiver/Transmitter (UART).

In the in-vehicle communication apparatus according to an example embodiment, the first module may include a microcontroller unit (MCU) configured to acquire and manage the state data of the vehicle via in-vehicle sensors, and the second module may include a communication module configured to perform long-distance communication with an external server.

An operation method of an in-vehicle communication apparatus according to an example embodiment includes acquiring state data of the vehicle by performing first communication with a first module configured to manage the state data of the vehicle and transmitting the state data of the vehicle by performing second communication with a second module configured to communicate with the outside.

In the operation method of the in-vehicle communication apparatus according to an example embodiment, acquiring the state data of the vehicle may include acquiring the data in units of a set size from the first module, and transmitting the state data of the vehicle may include transmitting the data in units of a set size to the second module.

In the operation method of the in-vehicle communication apparatus according to an example embodiment, acquiring the state data of the vehicle may include acquiring the following data after a set time delay upon acquiring the data in units of the set size from the first module.

In the operation method of the in-vehicle communication apparatus according to an example embodiment, the time delay may be set in consideration of the time required for the controller to acquire the data of the set size unit from the first module and the time required for transmitting the data of the set size unit to the second module.

In the operation method of the in-vehicle communication apparatus according to an example embodiment, a size of a transmission buffer of the vehicle communication apparatus may be set in consideration of the set time delay and an additional time delay caused by a size of a transmission buffer of the first module.

In the operation method of the in-vehicle communication apparatus according to an example embodiment, the first communication may be faster in data transmission rate per second than the second communication.

In the operation method of the in-vehicle communication apparatus according to an example embodiment, an interface of the first communication may be a Serial Peripheral Interconnect (SPI), and an interface of the second communication interface may be a Universal Asynchronous Receiver/Transmitter (UART).

In the operation method of the in-vehicle communication apparatus according to an example embodiment, the first module may include a Micro Controller Unit (MCU) configured to acquire and manage the state data of the vehicle via in-vehicle sensors, and the second module may include a communication module configured to perform long-distance communication with an external server.

### Advantageous Effects

An in-vehicle communication apparatus and an operation method thereof that are capable of supporting conversion between different communication interfaces (e.g., SPI and UART) and relaying data transmission and reception through time delay are provided. According to the proposed example embodiment, it is possible to improve the data transmission rate between the vehicle MCU and the LTE communication module and avoid data drop by processing a time delay set by a predetermined size unit of data transmission. Accordingly, it is possible to perform real-time LTE communication with an external server while minimizing the load on the vehicle MCU.

In addition, various effects that can be directly or qualitatively identified through this document can be provided.

### BRIEF DESCRIPTION OF DRAWINGS

In order to more clearly describe the example embodiments disclosed in this document and the technical solutions of the prior art, drawings required in the description of the example embodiments are briefly introduced below. It should be understood that the drawings below are for the purpose of explaining the example embodiments of the present specification and not for limiting purposes. In the drawings, certain components may be exaggerated or omitted for clarity of description.

FIG. 1 is a block diagram illustrating a configuration of a communication apparatus for relaying communication between a first module and a second module according to an example embodiment;

FIG. 2 illustrates a specific application example of a communication apparatus according to an example embodiment;

FIG. 3 is a data diagram for explaining a method of processing data in a communication apparatus according to an example embodiment;

FIG. 4A is a diagram illustrating a communication procedure between a first module and a second module according to conventional technology, and FIG. 4B is a diagram illustrating a communication procedure among a communication apparatus, a first module, and a second module according to an example embodiment;

FIG. 5 is a flowchart illustrating an operation method of a communication apparatus according to an example embodiment; and

FIG. 6 is a flowchart illustrating an operation method of a communication apparatus according to another example embodiment.

### MODES FOR PRACTICING INVENTION

Hereinafter, example embodiments disclosed in this document will be described in detail with reference to example drawings. In assigning reference numerals to the components of each drawing, it should be noted that the same components have the same reference numerals as much as possible even if they are displayed in different drawings. Detailed description of a well-known structure or function incorporated in the example embodiments disclosed in this document may be omitted to avoid obscuring the understanding of the example embodiments disclosed in this document.

Although the terms used in this document are selected, as much as possible, from general terms that are widely used at present while taking into consideration of the functions in the disclosure, these terms may be replaced by other terms based on intensions of those skilled in the art, customs, advent of new technologies, or the like. In addition, in a particular case, terms that are arbitrarily selected by the applicant may be used and, in this case, the meanings of these terms may be described in corresponding description parts of the invention. Accordingly, the terms used in this document should be construed on the basis of the practical meanings thereof and the overall content disclosed in this document rather than being simply construed based on names of the terms.

Terms used in this document are only used to describe a specific example embodiment and may not be intended to limit the scope of other example embodiments. The singular forms are intended to include the plural forms as well unless the context clearly indicates otherwise.

Hereinafter, preferred example embodiments of an in-vehicle communication apparatus and an operation method thereof will be described with reference to drawings.

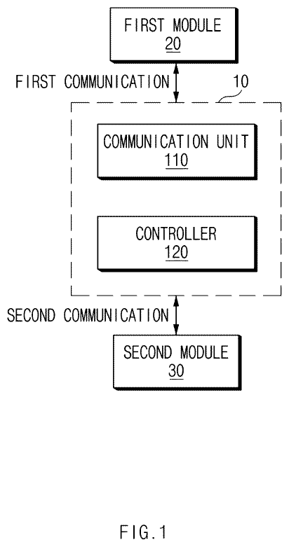

FIG. 1 is a block diagram illustrating a configuration of a communication apparatus for relaying communication between a first module and a second module according to an example embodiment. With reference to FIG. 1, a communication apparatus 10 according to an example embodiment includes a communication unit 110 and a controller 120. In this document, the components illustrated in the block diagram are classified according to their functions and roles, and each block does not necessarily have to be implemented as independent hardware or software. For example, separate components may be actually implemented as one device or program, or one component may be implemented as a combination of several devices and programs.

The communication unit 110 performs first communication with the first module 20 managing state data of the vehicle and performs the second communication with the second module 30 communicating with the outside. In this document, expressions such as “first” and “second” are used to distinguish components from each other and do not mean ranks or sequences between components.

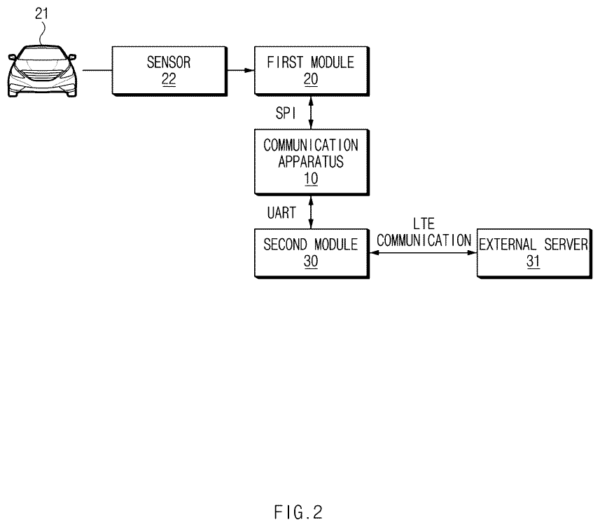

According to one example embodiment, the first module 20 includes a microcontroller unit (MCU) for obtaining and managing state data of the vehicle via sensors in the vehicle, and the second module 30 may include a communication module that performs a long-distance communication with an external server. Detailed operations of the first module 20 and the second module 30 will be described later with reference to FIG. 2.

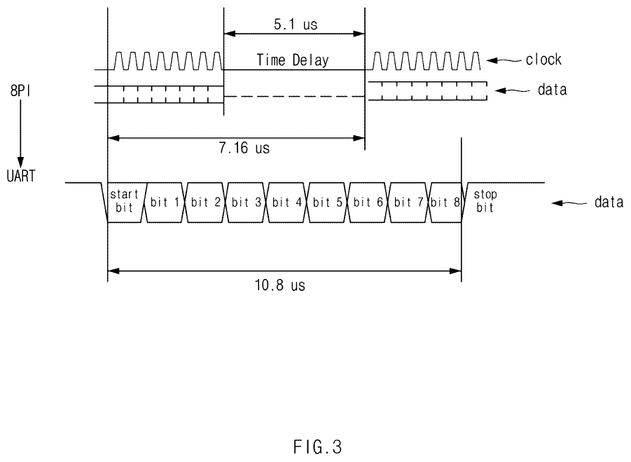

The controller 120 controls the communication apparatus 10 and the communication unit 110 to obtain vehicle state data from the first module 20 and transmit the vehicle state data to the second module 30. A detailed operation of the controller 120 processing data will be described later with reference to FIG. 3.

According to one example embodiment, the communication apparatus 10 may include an integrated circuit device converting a first communication interface to a second communication interface and a driver controlling the operation of the integrated circuit device. This is a division of components of the communication apparatus 10 into hardware and software. For example, the integrated circuit device may be an SPI-to-UART Bridge IC such as SC16IS740, and the driver may be an SPI-to-UART driver that controls the operation of the circuit.

FIG. 2 illustrates a specific application example of a communication apparatus according to an example embodiment. With reference to FIG. 2, the first module 20 (e.g., an MCU such as the ESP32-WROOM32) acquires state data (e.g., temperature, battery current, voltage, emissions information, etc.) of the vehicle 21 via a sensor 22 installed in the vehicle 21. The first module 20 may obtain the vehicle state data if necessary (e.g., when an abnormality occurs in the vehicle, when vehicle state data is periodically transmitted to an external server, or when a request for data is received from the LTE module).

The second module 30 (e.g., an LTE module such as EC25-E) may receive the vehicle data via the communication apparatus 10 and transmit the data to the external server 31 through long-distance communication. The external server 31 may collect state data of the vehicle at regular intervals or when an event occurs and may provide the first module 20 with information required for vehicle management via the second module 30.

According to an example embodiment, the first communication interface between the communication apparatus 10 and the first module 20 may be a serial peripheral interconnect (SPI), and the second communication interface between the communication apparatus 10 and the second module 30 may be a universal synchronous receiver/transmitter (UART). The SPI uses a synchronous serial communication standard and has the advantage of fast data transmission, but requires a separate clock signal for synchronization between the transmitting end and the receiving end in addition to the line for data transmission. On the other hand, the UART uses an asynchronous serial communication standard and sends parallel data bit by bit to an output pin according to a predetermined serial communication speed. The UART has the maximum transmission rate of 921600 bps, which is slow, and it requires a start/stop bit to prevent data drop because of no use of a clock for synchronization, which decreases the actual transmission rate to 80%, i.e., 737280 bps.

The LTE module used for data exchange with the MCU through the UART interface in the existing vehicle OBD has a problem in that the real-time LTE communication puts a heady load on the MCU due to the aforementioned low data rate and additional time delay of the UART. Accordingly, the communication apparatus according to an example embodiment may obtain vehicle state data from the MCU through the SPI interface and transmit the data to the LTE module through the UART interface to improve data transmission speed.

FIG. 3 is a data diagram for explaining a method of processing data in a communication apparatus according to an example embodiment. In an example embodiment, the controller 120 may acquire data through a first communication interface (SPI) and transmit the data through a second communication interface (UART). In the SPI, a separate clock signal is output for synchronizing the transmitting end and the receiving end, and data bits are transmitted according to the clock. The UART is asynchronous and does not require a clock signal, and a start bit and a stop bit are output before and after a 1-byte data signal.

In this way, the controller 120 acquires data from the first module 20 in units of a set size (e.g., 1 byte=8 bits) and transmits the data to the second module 30 in units of a set size (e.g., 1 byte=8 bits). When data of the same size is transmitted, data drop may occur due to the difference in maximum transmission rate between the first communication interface (SPI) and the second communication interface (UART) (in this case, the SPI is faster than the UART). For example, when data exceeding the buffer size of the communication apparatus 10 is input from the first module 20 without all data being transmitted to the second module 30, the excess data may be dropped.

In order to prevent this, the controller 120 according to an example embodiment may be configured to acquire next data after a set time delay when data of a set size unit is obtained. According to the example embodiment, the time delay may be set in consideration of the time required for the controller to obtain the data of the set size unit from the first module and the time required for transmitting the data of the set size unit to the second module.

In addition, the size of the transmit buffer of the communication apparatus may be set in consideration of the set time delay and additional time delay caused by the size of the transmit buffer of the first module.

For example, the controller 120 may acquire 1 byte of data from the first module 20 through the SPI interface and then start acquiring next 1 byte of data after a time delay of 5.16 μs, considering the size of the transmit buffer of the SPI-to-UART Bridge IC. In this case, a memory overflow may theoretically occur when the transmit buffer size reaches 189890 bytes, resulting in data drop. In addition, the size of the SPI Tx FIFO (First In First Out) register inside the MCU is also 64 bytes, resulting in an additional delay of 1.012 ms when all data is filled in the buffer. Considering all these circumstances, the transmit buffer size may be set to 1408 bytes.

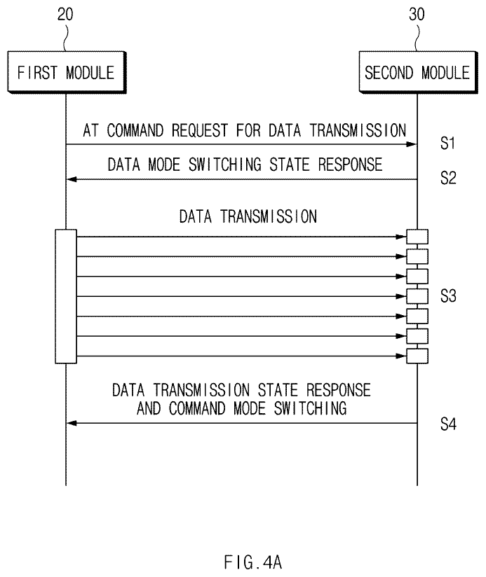

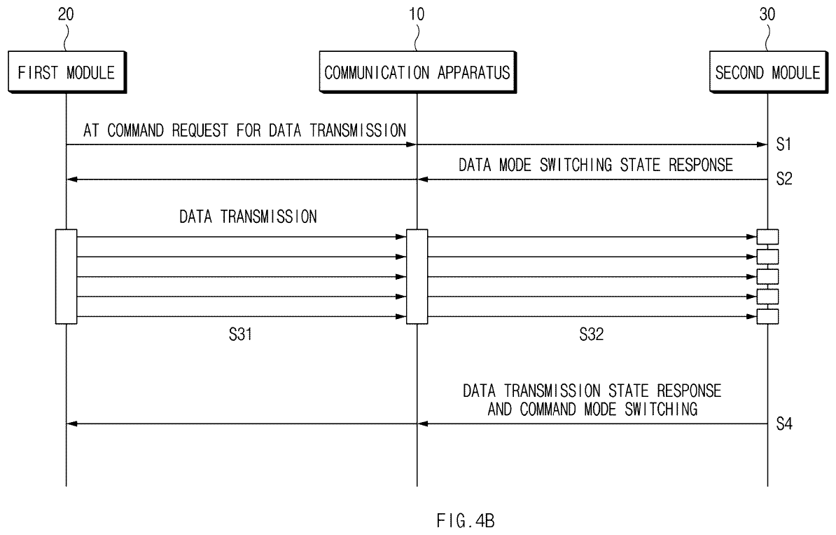

FIG. 4A is a diagram illustrating a communication procedure between a first module and a second module according to a conventional technology, and FIG. 4B is a diagram illustrating a communication procedure among a communication apparatus, a first module, and a second module according to an example embodiment.

In FIG. 4A, the first module 20 may be a vehicle MCU such as ESP32-WROOM32, and the second module 30 may be an LTE module such as EC25-E. In the conventional structure, communication between the first and second modules 20 and 30 is performed through an asynchronous serial communication type UART interface. First, when the first module 20 requests, at step S1, the second module 30 an AT command for data transmission, the second module 30 responds at step S2 to inform the first module 20 of being switched to the data mode. Afterward, data is sequentially transmitted from the first module 20 to the second module 30 at step S3, and when the data transmission is completed, the transition to the command mode is notified at step S40. As described above, this data transmission method is not only slow, but may be further delayed by being pulled back by other functions (CAN communication, data storage function, etc.) having high priority in the data transmission process. As a result, real-time LTE communication increases the load on the vehicle MCU.

On the other hand, in FIG. 4B, the communication apparatus 10 relaying communication between the first module 20 (e.g., a vehicle MCU) and the second module 30 (e.g., an LTE module) is adopted. The communication apparatus 10 may perform first communication (e.g., SPI) with the first module 20 and second communication (e.g., UART) with the second module 30. First, an AT command for data transmission is received from the first module 20 and relayed to the second module 30 at step S1, and a data mode switching state response is received from the second module 30 and relayed to the first module 20. In the data transmission process, as described above with reference to FIG. 3, data (e.g., vehicle state data) is obtained in units of a set size (1 byte) through the first communication (SPI) at step S31, and the following data is received after a set delay time (e.g., 5.16 μs). Simultaneously, the data is relayed to the second module 30 in units of a set size (1 byte) through the second communication (UART) at step S32. When the data transmission is completed, a command mode switching response is received from the second module 30 and relayed to the first module 20 at step S4.

As such, the in-vehicle communication apparatus according to an example embodiment supports different communication interfaces (SPI and UART) to improve the data transmission rate between the vehicle MCU and the LTE communication module. In addition, it is possible to avoid data drop, which is caused by interface conversion, through appropriate time delay processing.

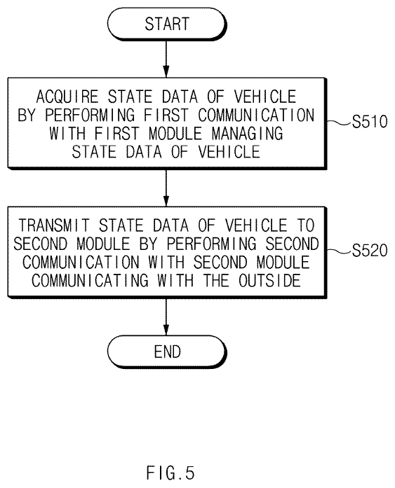

FIG. 5 is a flowchart illustrating an operation method of a communication apparatus according to an example embodiment. As described above, a communication apparatus according to an example embodiment may include a communication unit for communicating with other modules and a controller for controlling the operation of acquiring or transmitting data from or to other modules. In addition, by dividing the components into hardware and software, the communication apparatus may be composed of an integrated circuit device (e.g., an SPI-to-UART bridge IC) for communication interface conversion and a driver for controlling the operation thereof.

With reference to FIG. 5, first, a first communication is performed with a first module managing vehicle state data to acquire vehicle state data at S510. According to an example embodiment, the first module includes a vehicle MCU that obtains and manages state data of the vehicle through an in-vehicle sensor, and an interface of the first communication may be a serial synchronization type SPI.

Next, a second communication is performed with a second module that communicates with the outside, and a step of transmitting state data of the vehicle to the second module is performed at step S520. The second module includes a communication module (e.g., LTE module) that performs long-distance communication with an external server, and the interface for the second communication may be a serial asynchronous UART.

According to an example embodiment, since the data transmission rate per second of the first communication (SPI) is higher than that of the second communication (UART), the data transmission rate can be improved compared to the existing technology supporting only the second communication interface.

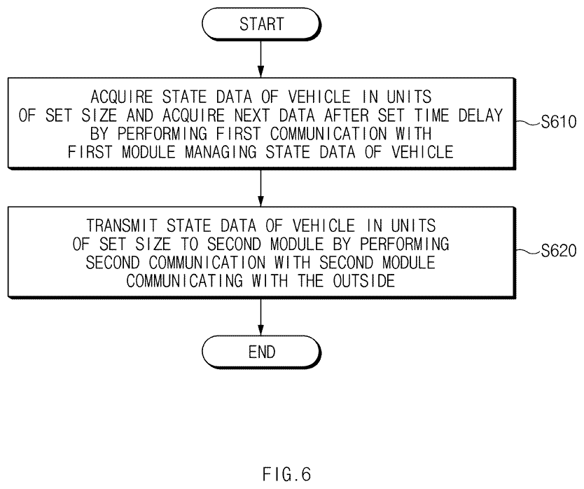

FIG. 6 is a flowchart illustrating an operation method of a communication apparatus according to another example embodiment.

With reference to FIG. 6, step S610 of acquiring vehicle state data in units of a set size and then acquiring the following data after a set time delay is performed through first communication with a first module for managing vehicle state data.

According to an example embodiment, the time delay may be set in consideration of a first time required to obtain data of the set size unit from the first module and a second time required to transmit the data of the set size unit to the second module. This is to prevent data drop caused by a difference between data transmission time using the SPI interface (first time) and data transmission time using the UART interface (second time). For example, when data is transmitted by 1 byte, the time delay may be set to 5.16 μs.

In addition, the size of the transmission buffer of the in-vehicle communication apparatus may be set in consideration of the set time delay and additional time delay caused by the size of the transmission buffer of the first module. For example, in the case of the time delay of 5.16 μs, a memory overflow may occur at the time when the transmission buffer size reaches 189890 bytes in theory, resulting in a data drop. In addition, the size of the SPI Tx FIFO (First In First Out) register inside the MCU is also 64 bytes, resulting in an additional delay of 1.012 ms when all data is filled in the buffer. Considering all these circumstances, the transmit buffer size may be set to 1408 bytes.

Next, step S620 of transmitting the state data of the vehicle to the second module in units of a set size is performed through second communication with the second module that communicates with the outside. The second module (e.g., an LTE module) may transmit the received vehicle state data to an external server using long-distance communication.

The operation method of the in-vehicle communication apparatus according to the above example embodiment may be implemented as an application or in the form of program commands that can be executed through various computer components and recorded on a computer-readable recording medium. The computer-readable recording medium may include program instructions, data files, data structures in individual or combined forms.

According to the above example embodiments, it is possible to improve the data transmission rate between the vehicle MCU and the LTE communication module and avoid data drop by delaying data transmission by a predetermined size unit. Accordingly, it is possible to perform real-time LTE communication with the outside while minimizing the load on the vehicle MCU.

Although the above description has been made of the example embodiments in which all components are combined or operate as one, there is no need to be limited to these example embodiments, and one or more of all components may be selectively combined and operated within the scope of the purpose. Also, the terms such as “comprise”, “include”, or “have” used above implies that the corresponding component may be present unless otherwise stated specifically, and thus it should be construed as being able to further include other components rather than exclude other components.

The above description is only an illustrative example of the technical idea disclosed in this document, and those skilled in the art to which the example embodiments disclosed in this document belong will be able to make various modification and changes without departing from the subject matter of the example embodiments disclosed in this document.

Therefore, the example embodiments disclosed in this document are not intended to limit but to describe the technical idea disclosed in this document, and the scope of the technical idea disclosed in this document is not limited by these example embodiments. The scope of protection of technical ideas disclosed in this document shall be construed by the following claims, and all technical ideas within the scope equivalent thereto shall be construed as being within the scope of the rights of this document.

1. An in-vehicle communication apparatus, comprising:
a communicator configured to perform a first communication with a first module configured to manage state data of a vehicle and to perform a second communication with a second module configured to communicate with an external device outside the vehicle; and
a controller configured to acquire the state data of the vehicle from the first module and to transmit the state data of the vehicle to the second module.

2. The apparatus of claim 1, wherein the controller is further configured to acquire data in units of a set size from the first module and transmit the data in units of the set size to the second module.

3. The apparatus of claim 2, wherein the controller is further configured to acquire next data after a set time delay upon acquiring the data in units of the set size from the first module.

4. The apparatus of claim 3, wherein the set time delay is set based on an amount of time required for the controller to acquire a unit of data of the set size from the first module and an amount of time required for the controller to transmit the unit of data of the set size to the second module.

5. The apparatus of claim 4, further comprising a transmission buffer,
wherein a size of the transmission buffer of the in-vehicle communication apparatus is set based on the set time delay and an additional time delay caused by a size of a transmission buffer of the first module.

6. The apparatus of claim 1, wherein the first communication is faster in data transmission rate per second than the second communication.

7. The apparatus of claim 6, wherein an interface of the first communication is a Serial Peripheral Interconnect (SPI), and an interface of the second communication interface is a Universal Asynchronous Receiver/Transmitter (UART).

8. The apparatus of claim 1, wherein:
the first module comprises a microcontroller unit (MCU) configured to acquire and manage the state data of the vehicle via in-vehicle sensors, and
the second module comprises a communication module configured to perform long-distance communication with an external server.

9. An operation method of an in-vehicle communication apparatus, the method comprising:
acquiring state data of a vehicle by performing a first communication with a first module configured to manage the state data of the vehicle; and
transmitting the acquired state data of the vehicle by performing a second communication with a second module configured to communicate with an external device outside the vehicle.

10. The method of claim 9, wherein:
the acquiring of the state data of the vehicle comprises acquiring data in units of a set size from the first module, and
the transmitting of the acquired state data of the vehicle comprises transmitting the data in units of the set size to the second module.

11. The method of claim 10, wherein the acquiring of the state data of the vehicle further comprises acquiring next data after a set time delay upon acquiring the data in units of the set size from the first module.

12. The method of claim 11, wherein the time delay is set based on an amount of time required to acquire a unit of data of the set size from the first module and an amount of time required to transmit the unit of data of the set size to the second module.

13. The method of claim 12, wherein a size of a transmission buffer of the in-vehicle communication apparatus is set in based on the set time delay and an additional time delay caused by a size of a transmission buffer of the first module.

14. The method of claim 9, wherein the first communication is faster in data transmission rate per second than the second communication.

15. The method of claim 14, wherein an interface of the first communication is a Serial Peripheral Interconnect (SPI), and an interface of the second communication interface is a Universal Asynchronous Receiver/Transmitter (UART).

16. The method of claim 9, wherein_:
the first module comprises a microcontroller unit (MCU) configured to acquire and manage the state data of the vehicle via in-vehicle sensors, and
the second module comprises a communication module configured to perform long-distance communication with an external server.
